(19) United States
(12) Patent Application Publication
(10) Pub. No.: US 2026/0175367 A1
(43) Pub. Date: Jun. 25, 2026

(54) METHOD FOR AUTOMATICALLY CONTROLLING THE TRIGGERING OF THE SHARPENING OF THE CUTTING EDGE OF A CUTTING BLADE FOR A CUTTING MACHINE

(71) Applicants: LECTRA, Paris (FR); AMVALOR, Paris (FR); UNIVERSITE DE BORDEAUX, Bordeaux (FR); INSTITUT POLYTECHNIQUE DE BORDEAUX, Talence (FR); CENTRE NATIONAL DE LA RECHERCHE SCIENTIFIQUE, Paris (FR); ECOLE NATIONALE SUPERIEURE D'ARTS ET METIERS (ENSAM), Paris (FR)

(72) Inventors: Didier CHABIRAND, Cestas (FR); Olivier CAHUC, Canejan (FR); Philippe DARNIS, Louchats (FR); Raynald LAHEURTE, Gradignan (FR); Intissar FARAH, Leognan (FR)

(21) Appl. No.: 18/729,626

(22) PCT Filed: Jan. 25, 2023
(86) PCT No.: PCT/FR2023/050101

§ 371 Date: Jul. 17, 2024

(30) Foreign Application Priority Data
Jan. 27, 2022 (FR) FR2200700

(51) Int. Cl. B24D 15/08; B24B 3/36; B24B 3/54

(52) U.S. Cl. CPC B24D 15/081; B24B 3/36; B24B 3/368; B24B 3/54; B24B 3/546; B24D 15/08

(57) ABSTRACT

A method for automatically controlling a triggering of a sharpening of the sharp edge of a cutting blade for a cutting machine, includes determining components of a mechanical action torsor at the guiding point of the cutting blade in the blade reference, determining an admissible threshold value for a variable established from the at least one of the components of the mechanical action torsor and based on geometric parameters of the cutting blade and on thickness and material characteristics of the mattress to be cut, monitoring during the cutting of the material variations in amplitude of the variable chosen to determine the threshold value, and automatically triggering an alert to request a sharpening cycle of the sharp edge of the cutting blade as soon as the amplitude of the variable chosen to determine the threshold value reaches said threshold value.

### TECHNICAL FIELD

The present invention relates to the general field of automatically cutting, with a vibrating blade, a mattress of flexible material placed on a cutting table and in the form of a single ply or of a stack of plies.

It concerns more specifically the automatic control of a triggering of an operation of sharpening the sharp edge of the cutting blade fitted to such cutting machines.

### PRIOR ART

One field of application of the invention is that of the automatic cutting of pieces from a textile or non-textile flexible material (such as leather), particularly in the clothing, furnishing or car upholstery industry.

A known method for automatically cutting pieces from a flexible material consists in bringing the material onto a fixed or movable cutting support of the cutting table, in the form of a single ply or of a stack of plies forming a mattress, and in cutting the pieces by means of a cutting head moving above the cutting support of the table according to a previously defined placement program.

Typically, the cutting head of such a machine is formed of a steel blade which is vibrated vertically along the direction of its sharp edge in order to cut the material. A rotating blade guide serves as a slide for the blade and ensures its rotation.

It is also known that the cutting blade loses its cutting power as the cutting operation takes place so that it is necessary to regularly carry out operations of sharpening its sharp edge.

For this purpose, the cutting head can be equipped with an automatic sharpening system composed of two or three abrasive belts. When a sharpening operation is triggered, the blade rises and the abrasive belts of the sharpening system sharpen both faces of the sharp edge of the blade in order to reform the edge.

These sharpening operations are generally periodic and distributed over time in a linear manner throughout the life of the blade, regardless of the actual state of its sharp edge.

The sharpening frequency is most often determined empirically by taking into account in particular the nature of the cut material and the wear of the blade which is generated by a sharpening operation. The latter corresponds to a loss of material and is determined experimentally by an abrasion law depending on the number of sharpening operations, the dimension of the blade and the type of abrasive belt used. The position of the sharp edge is calculated based on the number of sharpening cycles carried out.

This empirical method for determining the sharpening frequency of the cutting blade is not optimal. Indeed, this method does not take into account the variability of the abrasive power throughout the life of the sharpening belts. The initial abrasive power of the belts as well as the hardness and geometry of the cutting blades are not identical from one blade to another or from one set of belts to another, the empirical method does take into account these variabilities. Given the diversity of the materials cut, the empirical method requires numerous tests to be implemented in order to determine the best set of parameters for each material/belt/blade triplet or to limit the choices by keeping a single set of parameters for several materials thus limiting the inputs of an optimal parameterization.

### DISCLOSURE OF THE INVENTION

The main aim of the present invention is therefore to propose a method for automatically controlling the triggering of the sharpening the sharp edge of a cutting blade.

In accordance with the invention, this aim is achieved thanks to a method for automatically controlling a triggering of a sharpening of the sharp edge of a cutting blade for a machine for cutting a mattress of flexible material, comprising:
determining components of a mechanical action torsor at the guiding point of the cutting blade in the blade reference, the components comprising: the frontal force, the lateral force, the vertical force, the rolling moment, the pitching moment, and the yawing moment of the cutting blade;
determining an admissible threshold value for a variable established from the at least one of the components of the mechanical action torsor and based on geometric parameters of the cutting blade and on thickness and material characteristics of the mattress to be cut;
monitoring, during the cutting of the material, variations in amplitude of the variable chosen to determine the threshold value; and
automatically triggering an alert to request a sharpening cycle of the sharp edge of the cutting blade as soon as the amplitude of the variable chosen to determine the threshold value reaches said threshold value.

The method according to the invention is remarkable in that, from the components of the mechanical action torsor at the guiding point of the cutting blade, it is possible to automatically control the triggering of the sharpening operation. The inventors have indeed highlighted the existence of a relation between the overall nature of the mechanical action torsor at the guiding point of the blade and the state of the latter. The mechanical action torsor identifies the forces experienced by the blade in the three directions. It is determined from measurements coming from a dynamometer installed in the presser foot of the cutting head and as described in patent application FR 3,108,542, whose content is incorporated here by reference.

The method according to the invention thus makes it possible to trigger a sharpening of the sharp edge of the blade only and as soon as the state of the sharp edge requires it. This results in productivity gains, consideration of the variabilities (hardness, geometries, composition, manufacture, etc.) of the blades and the sharpening belts or the mechanical components located in the environment of these consumables, simplification of the parameterization of the sharpening cycles for the operators.

According to one embodiment, the variable chosen to determine the threshold value corresponds to the vertical force component of the cutting blade.

In this embodiment, the variation in amplitude of the vertical force of the cutting blade during the cutting of the material is advantageously given by the following equation:

$${F}_{Z} = \sqrt{( 4 \times {M}_{Y}^{2} ) / {L}^{2} - ( {F}_{X}^{2} + {F}_{Y}^{2} )} \qquad [ Math . 1 ]$$

wherein F_{z} is the amplitude of the vertical force of the cutting blade, M_{y} is the amplitude of the pitching moment of the cutting blade, Fₓ is the amplitude of the frontal force of the cutting blade, F_{Y} is the amplitude of the lateral force applied to the blade, and L is the thickness of the mattress to be cut.

According to one embodiment, the variable chosen to determine the threshold value corresponds to an inclination of the central axis of the cutting blade relative to the vertical axis, the variations in inclination of the central axis of the cutting blade relative to the vertical axis being calculated from all the values of the components of the mechanical action torsor.

In this other embodiment, the variations in inclination of the central axis of the cutting blade relative to the vertical axis are calculated, for each point P with coordinates Ptₓᵢ, Pt_{yi}, Pt_{zi} of the central axis, by the following equation:

$${γ}_{z} = \frac{1}{m} {\sum }_{i = 1}^{m} arctan ( \sqrt{{Pt}_{x i}^{2} + {Pt}_{y i}^{2}} / {Pt}_{z i} ) \qquad [ Math . 2 ]$$

with m representing the number of acquisition points per measurement.

Advantageously, the method further comprises comparing the amplitudes of the variable chosen to determine the threshold value before and after a sharpening cycle of the sharp edge of the cutting blade in order to determine whether the sharpening belts of the sharpening tool need be replaced. Indeed, it was also noted by the inventors that the regenerative capacity of the sharp edge by the sharpening belts decreases as a function of the number of sharpening operations carried out, which results in a value of the variable used after sharpening which gets closer and closer to the threshold value. This additional step of the method thus makes it possible to determine the moment when the sharpening belts must be changed in order to maintain a cutting power compatible with the quality requirements and not to significantly increase the frequency of the sharpening operations that penalize the productivity of the cutting machines.

In this case, the method can further comprise automatically triggering an alert to request the change of the sharpening belts of the sharpening tool as soon as the difference between the amplitude of the variable chosen to determine the threshold value after a sharpening cycle and the amplitude of the variable chosen to determine the threshold value before the sharpening operation becomes lower than a predetermined threshold.

Preferably, a sharpening cycle advantageously comprises an abrasion phase on each side of the cutting blade by sharpening belts in order in particular to reduce the radius of the sharp edge and increase its roughness.

### BRIEF DESCRIPTION OF THE DRAWINGS

FIG. 1 is a flowchart showing the different steps of the method according to the invention.

FIGS. 2A, 2B and 2C represent curves of evolution of the vertical force component of different cutting blades.

FIG. 3 represents curves of evolution of the inclination of the central axis of the cutting blade relative to the vertical axis.

### DESCRIPTION OF THE EMBODIMENTS

The invention applies to the automated cutting of pieces from a flexible material in the form of a mattress.

Such a cutting operation is generally carried out by means of a cutting machine equipped with a horizontal cutting support on which the flexible material to be cut is brought.

A cutting head carrying a vibrating blade is mounted on a crossbar which is caused to move along the cutting support while the cutting head moves simultaneously along the crossbar so as to be able to follow the different cutting trajectories calculated by cutting software.

Typically, a presser foot is mounted on the lower part of the cutting head in order to press, in a controlled force, the flexible material onto its cutting support during cutting, the position of this presser foot being adaptable depending on the height of the mattress laid on the cutting support. Thus, the presser foot makes it possible to maintain the guidance of the cutting blade as close as possible to the mattress.

The invention proposes a method for automatically controlling a triggering of a sharpening of the sharp edge of the cutting blade of such a cutting machine.

### Generally, the Method According to the Invention Provides for the Following Steps:

determining components of a mechanical action torsor at the guide point of the cutting blade, the components comprising: the frontal force, the lateral force, the vertical force, the rolling moment, the pitching moment, and the yawing moment of the cutting blade
determining an admissible threshold value for a variable established from the at least one of the components of the mechanical action torsor and based on geometric parameters of the cutting blade and on thickness and material characteristics of the mattress to be cut
monitoring, during the cutting of the material, variations in amplitude of the variable chosen to determine the threshold value, and
automatically triggering an alert to request a sharpening cycle of the sharp edge of the cutting blade as soon as the amplitude of the variable chosen to determine the threshold value reaches said threshold value.

The variable chosen to determine the threshold value can correspond either to the vertical force component of the cutting blade, or to an inclination of the central axis of the cutting blade relative to the vertical axis.

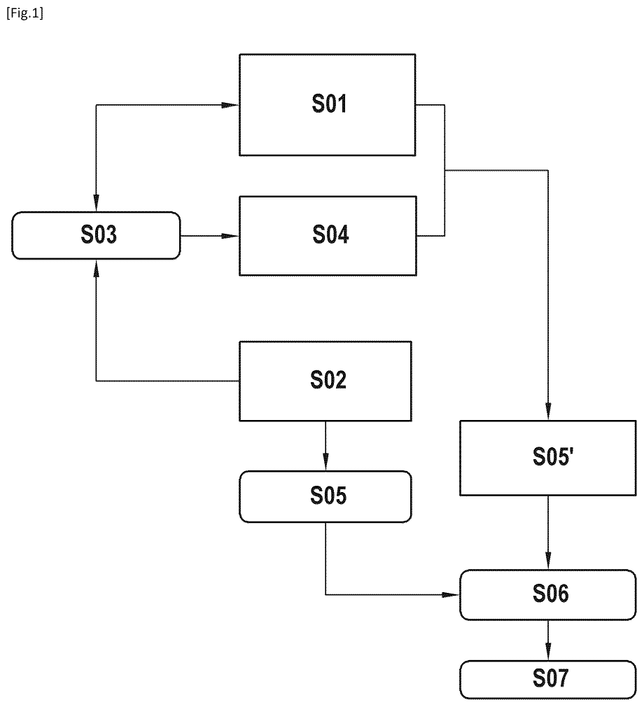

In practice, the method according to the invention is an algorithm implemented by software means equipping, for example, a computer workstation and the main steps of which are illustrated in FIG. 1.

The algorithm is inputted with input parameters (step S01) entered by the operator. These include the characteristics of the cutting blade (namely its geometry and the materials that constitute it), the characteristics of the material to be cut (namely thickness and material), and the maximum admissible value of the inclination of the central axis of the cutting blade in its new state.

During a step S02, it is also planned to determine the five components of a mechanical action torsor at the guiding point of the cutting blade, namely: the frontal force Fₓ, the lateral force F_{z}, the rolling moment Mₓ, the pitching moment M_{y}, and the yawing moment M_{z} of the cutting blade.

During the vertical vibration and when cutting the material, the cutting blade is subjected to numerous forces. The frontal force Fₓ is the force experienced by the cutting edge of the blade when it is brought into contact with the material during the cutting operation. The lateral force F_{z} is the force experienced by one of the flanks of the blade when it is brought into contact with the material during the cutting operation. As for the vertical force, it is the force experienced by the blade in its vibrating movement along the vertical axis.

This mechanical torsor can be determined by means of the method described in patent application FR 3,108,542, whose content is incorporated here by reference.

Briefly, the method described in this document provides for the use of a five-component dynamometer positioned on the presser foot and making it possible, from an algorithm based on the establishment of a calibration matrix of the dynamometer, to determine in real time the three-dimensional forces experienced by the cutting blade during the cutting operation.

More specifically, the dynamometer can comprise three triaxial piezoelectric sensors which are mounted in the presser foot by being distributed around a longitudinal axis of the blade or three coupled strain gauge bridges which are mounted on branches of the presser foot distributed about a longitudinal axis of the blade in order to form at least three complete bridges, or five decoupled strain gauge bridges which are mounted on the presser foot.

From the data derived from steps S01 and S02, the method provides for determining a threshold value admissible by the cutting blade (step S03). This threshold value corresponds to a maximum admissible value either by the vertical force component of the cutting blade, or by the inclination of the central axis of the cutting blade relative to the vertical axis (depending on the variable chosen for controlling the triggering of a sharpening). This parameterization will for example be determined from a predetermined chart and/or by setting a maximum value of the tangent of the curve comprised between the initial value of the slope and the upper plateau, this value will be adapted based on the safety coefficient to be integrated (close to zero: without safety margin, close to the initial tangent: with a large safety margin).

The cutting parameters (namely the conditions and strategies for cutting the pieces, as well as the wear of the sharp edge of the cutting blade by sharpening operation) are then determined from the admissible threshold value by the cutting blade (step S04).

As indicated previously, the method according to the invention provides for two approaches: the first one by monitoring continuously and in real time the amplitude of the vertical force component F_{z} of the cutting blade, and the second one by monitoring continuously and in real time the inclination of the central axis of the cutting blade relative to the vertical axis.

In the first approach, the method according to the invention provides, during a step S05, for determining continuously and in real time the variation in amplitude of the vertical force component F_{Z} of the cutting blade from the mechanical torsor determined in step S02.

In practice, the variation in amplitude of the vertical force of the cutting blade during the cutting of the material is given by the following equation:

$${F}_{Z} = \sqrt{( 4 \times {M}_{Y}^{2} ) / {L}^{2} - ( {F}_{X}^{2} + {F}_{Y}^{2} )} \qquad [ Math . 3 ]$$

wherein F_{z} is the amplitude of the vertical force of the cutting blade, M_{y} is the amplitude of the pitching moment of the cutting blade, Fₓ is the amplitude of the frontal force of the cutting blade, F_{y} is the amplitude of the lateral force applied to the blade, and L is the thickness of the mattress to be cut.

The amplitudes over time of the vertical force component F_{z} of the cutting blade can thus be easily calculated and compared with the threshold value admissible by the cutting blade determined in step S03 (see step S06).

As soon as the amplitude of the vertical force component F_{z} reaches the admissible threshold value, the algorithm according to the invention automatically triggers an alert to request a sharpening cycle of the sharp edge of the cutting blade.

Upon receipt of this alert, the operator will therefore program an operation of sharpening the sharp edge of the cutting blade at the end of the cutting cycle (step S07). For this purpose, when a sharpening operation is triggered, the blade rises and the abrasive belts of the sharpening system sharpen both faces of the sharp edge of the blade in order to reform the edge.

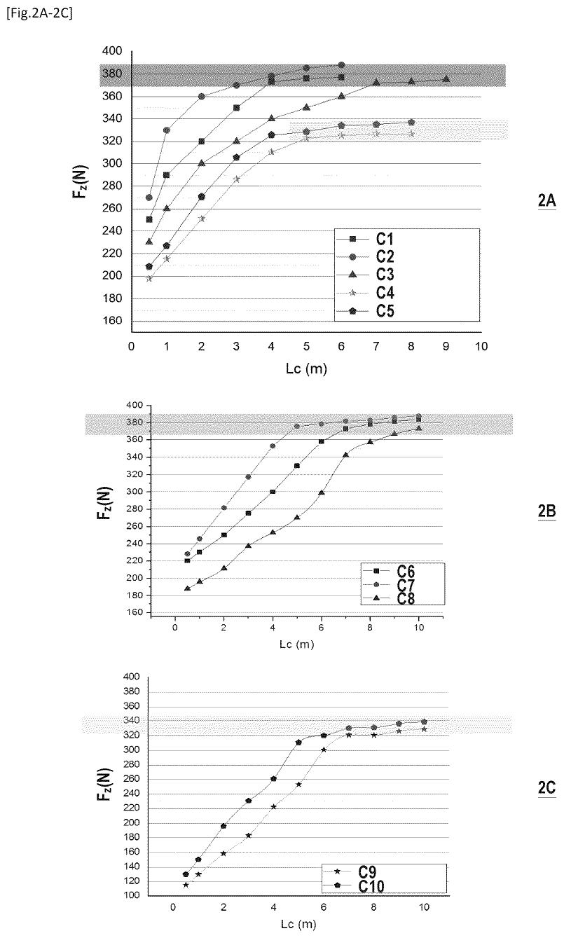

FIGS. 2A to 2C represent different examples of curves of evolution of the vertical force component of different cutting blades.

The curves represented in FIG. 2A were obtained with the following cutting blade and cutting parameter characteristics:
Material of the cutting blade: high-speed steel designated under European standard HS 6-5-2
Material to be cut: denim (namely a cotton twill used for making “jeans”)
Thickness of the mattress to be cut: 40 mm (namely 40 layers of 1 mm each).

In FIG. 2A, the abscissa corresponds to the cutting length Lc (in m) and the ordinate to the amplitude F_{Z} of the vertical force of the cutting blade (in N).

The different curves C1 to C5 in FIG. 2A correspond to different configurations in terms of cutting speed, vibration frequency of the cutting blade and cutting angle which are listed in the table below.

TABLE 1

| | Curve C1 | | Curve C2 | | Curve C3 | | Curve C4 | | Curve C5 | |
|---|---|---|---|---|---|---|---|---|---|---|
| Speed | 40 | m/min | 60 | m/min | 40 | m/min | 40 | m/min | 60 | m/min |
| Frequency | 50 | Hz | 50 | Hz | 100 | Hz | 100 | Hz | 100 | Hz |

| | | | | | |
|---|---|---|---|---|---|
| Cutting angle | 30° | 30° | 30° | 25° | 25° |

This FIG. 2A highlights that, for curves C1 to C3, the admissible threshold value for the amplitude F_{Z} of the vertical force of the cutting blade is located around 380 N. For the curves C4 and C5, this admissible threshold value is lower and is around 330 N.

These levels, which differ depending on the cutting blade and cutting parameter characteristics, indicate wear of the sharp edge of the cutting blade.

Also, as soon as the amplitude F_{z} of the vertical force of the cutting blade for the input parameters reaches this admissible threshold value, the algorithm automatically triggers an alert to program an operation of sharpening the sharp edge of the cutting blade.

FIGS. 2B and 2C are evolution curves obtained from other input characteristics, namely:
Material of the cutting blade: high-speed steel designated under European standard HS 4-3-8)
Material to be cut: denim
Thickness of the mattress to be cut: 40 mm (i.e. 40 plies of 1 mm each)

The different curves C6 to C10 in FIGS. 2B and 2C correspond to the configurations listed in the table below.

TABLE 2

| | Curve C6 | | Curve C7 | | Curve C8 | | Curve C9 | | Curve C10 | |
|---|---|---|---|---|---|---|---|---|---|---|
| Speed | 40 | m/min | 60 | m/min | 40 | m/min | 40 | m/min | 60 | m/min |
| Frequency | 50 | Hz | 50 | Hz | 100 | Hz | 100 | Hz | 100 | Hz |

| | | | | | |
|---|---|---|---|---|---|
| Cutting angle | 30° | 30° | 30° | 25° | 25° |

These FIGS. 2B and 2C make it possible to highlight that, for the curves C6 to C8, the admissible threshold value for the amplitude F_{z} of the vertical force of the cutting blade is located around 380 N and, for the curves C9 and C10, this admissible threshold value is lower and is around 330 N.

In the second approach, the method according to the invention provides, during a step S05′, for determining continuously and in real time the variation in amplitude of the inclination of the central axis of the cutting blade relative to the vertical axis.

Indeed, it has been demonstrated that the introduction of the central axis of the cutting blade makes it possible to synthesize all the components of the mechanical action torsor into an entity characteristic of the state of the blade during the cutting. Particularly, it has been shown that the inclination of the central axis, during a complete revolution of the blade, reflects the ability of the blade to make cuts meeting the specifications. Indeed, the use of the central axis associated with criteria for characterizing its evolution makes it possible to qualify the ability of the blade to cut a flexible material.

The amplitude of the inclination of the central axis of the cutting blade relative to the vertical axis is obtained by calculation from all the values of the components of the mechanical action torsor, namely the frontal force Fₓ, the lateral force F_{z}, the rolling moment Mₓ, the pitching moment M_{y}, and the yawing moment M_{z} of the cutting blade obtained in step S02, and the vertical force F_{z} obtained in step S05.

The mechanical action components evolve depending on the wear of the cutting edge and the degradation of the cutting power of the blade. The evolution of the cutting forces and moments leads to an evolution of the slider (the direction of the central axis) of the mechanical action torsor. The central axes then follow the direction of the resultant of the forces. As the evolution of the vertical force F_{z} is more significant than the other components of the torsor (Fₓ and F_{Y}), it is therefore interesting to study the evolution of the direction of the central axis relative to the vertical measuring axis.

Also, the variations in inclination of the central axis of the cutting blade relative to the vertical axis are calculated, for each point P with coordinates Ptₓᵢ, Pt_{yi}, Pt_{zi} of the central axis, by the following equation:

$${γ}_{z} = \frac{1}{m} {\sum }_{i = 1}^{m} arctan ( \sqrt{P {t}_{x i}^{2} + P {t}_{y i}^{2}} / {Pt}_{z i} ) \qquad [ Math . 4 ]$$

wherein γ_{z} is the inclination of the central axis of the cutting blade relative to the vertical axis and m represents the number of acquisition points per measurement.

The amplitudes over time of the inclination of the central axis of the cutting blade can thus be easily calculated and compared with the threshold value admissible by the cutting blade determined in step S03 (see step S06).

As soon as the amplitude of the component of inclination of the central axis of the cutting blade reaches the admissible threshold value, the algorithm according to the invention automatically triggers an alert to request a sharpening cycle of the sharp edge of the cutting blade.

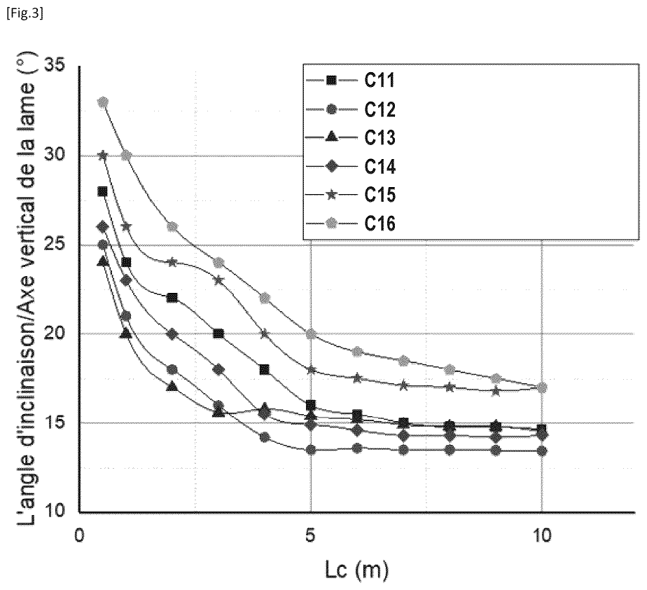

FIG. 3 represents different examples of curves of evolution of the inclination of the central axis of the same cutting blade operating with different cutting parameters.

The Curves Represented in FIG. 3 were Obtained with the Following Cutting Parameters:
Material to be cut: denim
Thickness of the mattress to be cut: 40 mm

The different curves C11 to C16 correspond to different configurations in terms of cutting speed, vibration frequency of the cutting blade and cutting angle which are listed in the table below.

TABLE 3

| | Curve C11 | | Curve C12 | | Curve C13 | | Curve C14 | | Curve C15 | | Curve C16 | |
|---|---|---|---|---|---|---|---|---|---|---|---|---|
| high-speed | HS 4-3-8 | | HS 6-5-2 | | HS 4-3-8 | | HS 4-3-8 | | HS 6-5-2 | | HS 4-3-8 | |
| steel blade | | | | | | | | | | | | |
| Speed | 40 | m/min | 40 | m/min | 40 | m/min | 60 | m/min | 40 | m/min | 60 | m/min |
| Frequency | 100 | Hz | 100 | Hz | 50 | Hz | 100 | Hz | 100 | Hz | 100 | Hz |

| | | | | | | |
|---|---|---|---|---|---|---|
| Cutting | 30° | 30° | 30° | 30° | 25° | 25° |
| angle | | | | | | |

This FIG. 3 highlights that the admissible threshold value for the inclination of the central axis of the cutting blade is located around 15° regardless of the cutting parameters and the characteristics of the blade. This level shows wear on the sharp edge of the cutting blade.

Also, as soon as the inclination of the central axis of the cutting blade for the input parameters reaches this admissible threshold value, the algorithm automatically triggers an alert to program an operation of sharpening the sharp edge of the cutting blade.

According to one advantageous arrangement of the invention (applicable to the two approaches described previously), it can be provided to compare the amplitudes of the variable chosen to determine the threshold value before and after a sharpening cycle of the sharp edge of the cutting blade in order to determine whether the sharpening belts of the sharpening tool need to be replaced.

Indeed, it was found that the regenerative capacity of the sharp edge by the sharpening belts decreases as a function of the number of sharpening operations carried out, which results in a value for the vertical force F_{z} or for the inclination of the central axis of the cutting blade after a sharpening operation which gets closer and closer to the previously determined admissible threshold value.

This advantageous arrangement therefore provides for automatically triggering an alert to request the change of the sharpening belts of the sharpening tool as soon as the difference between the amplitude of the variable chosen to determine the threshold value after a sharpening cycle and the amplitude of the variable chosen to determine the threshold value before the sharpening operation becomes lower than a predetermined threshold.

This advantageous arrangement thus makes it possible to determine the moment when the sharpening belts must be changed in order to maintain a cutting power compatible with the quality requirements and not to significantly increase the frequency of the sharpening operations that penalize the productivity of the cutting machines.

1.-8. (canceled)

9. A method for automatically controlling a triggering of a sharpening of the sharp edge of a cutting blade for a machine for cutting a mattress of flexible material, comprising:
determining components of a mechanical action torsor at the guiding point of the cutting blade in the blade reference, the components comprising: the frontal force, the lateral force, the vertical force, the rolling moment, the pitching moment, and the yawing moment of the cutting blade;
determining an admissible threshold value for a variable established from the at least one of the components of the mechanical action torsor and based on geometric parameters of the cutting blade and on thickness and material characteristics of the mattress to be cut;
monitoring, during the cutting of the material, variations in amplitude of the variable chosen to determine the threshold value; and
automatically triggering an alert to request a sharpening cycle of the sharp edge of the cutting blade as soon as the amplitude of the variable chosen to determine the threshold value reaches said threshold value.

10. The method according to claim 9, wherein the variable chosen to determine the threshold value corresponds to the vertical force component of the cutting blade.

11. The method according to claim 10, wherein the variation in amplitude of the vertical force of the cutting blade during the cutting of the material is given by the following equation:
$${F}_{Z} = \sqrt{( 4 \times {M}_{Y}^{2} ) / {L}^{2} - ( {F}_{X}^{2} + {F}_{Y}^{2} )} \qquad [ Math . 5 ]$$
wherein Fz is the amplitude of the vertical force of the cutting blade, My is the amplitude of the pitching moment of the cutting blade, Fx is the amplitude of the frontal force of the cutting blade, Fy is the amplitude of the lateral force applied to the blade, and L is the thickness of the mattress to be cut.

12. The method according to claim 9, wherein the variable chosen to determine the threshold value corresponds to an inclination of the central axis of the cutting blade relative to the vertical axis, the variations in inclination of the central axis of the cutting blade relative to the vertical axis being calculated from all the values of the components of the mechanical action torsor.

13. The method according to claim 12, wherein the variations in inclination of the central axis of the cutting blade relative to the vertical axis are calculated, for each point P with coordinates Ptxi, Ptyi, Ptzi of the central axis, by the following equation:
$${γ}_{z} = \frac{1}{m} {\sum }_{i = 1}^{m} arctan ( \sqrt{P {t}_{x i}^{2} + P {t}_{y i}^{2}} / {Pt}_{z i} ) \qquad [ Math . 6 ]$$
wherein m represents the number of acquisition points per measurement.

14. The method according to claim 9, further comprising comparing the amplitudes of the variable chosen to determine the threshold value before and after a sharpening cycle of the sharp edge of the cutting blade in order to determine whether the sharpening belts of the sharpening tool need to be replaced.

15. The method according to claim 14, further comprising automatically triggering an alert to request the change of the sharpening belts of the sharpening tool as soon as the difference between the amplitude of the variable chosen to determine the threshold value after a sharpening cycle and the amplitude of the variable chosen to determine the threshold value before the sharpening operation becomes lower than a predetermined threshold.

16. The method according to claim 9, wherein a sharpening cycle comprises an abrasion phase on each side of the cutting blade by sharpening belts in order in particular to reduce the radius of the sharp edge and increase its roughness
